(19) United States
(12) Patent Application Publication
(10) Pub. No.: US 2011/0235583 A1
(43) Pub. Date: Sep. 29, 2011

(54) METHOD AND APPARATUS FOR DOWNLOADING DATA IN MOBILE COMMUNICATION SYSTEM

(75) Inventor: Jong-Man PARK, Suwon-si (KR)

(73) Assignee: SAMSUNG ELECTRONICS CO. LTD., Suwon-si (KR)

(21) Appl. No.: 13/070,953

(22) Filed: Mar. 24, 2011

(30) Foreign Application Priority Data
Mar. 29, 2010 (KR) 10-2010-0027729

(51) Int. Cl. H04W 40/00

(52) U.S. Cl. 370/328

(57) ABSTRACT

A method and apparatus for downloading data in a mobile communication system are provided. A method of a mobile terminal for downloading data in a mobile communication system includes receiving a transmit (TX) data existence indication message from a server, determining an access network according to an amount of TX data included in the received TX data existence indication message, performing a data connection through the access network, and receiving the data from the server.

### PRIORITY

This application claims the benefit under 35 U.S.C. §119(a) of a Korean patent application filed in the Korean Intellectual Property Office on Mar. 29, 2010, and assigned Serial No. 10-2010-0027729, the entire disclosure of which is hereby incorporated by reference.

### BACKGROUND OF THE INVENTION

1. Field of the Invention

The present invention relates to a mobile communication system. More particularly, the present invention relates to a method and apparatus for determining a network for downloading data in a mobile communication system.

2. Description of the Related Art

A mobile communication system provides services that allow a mobile terminal to synchronize or download data from a server without the request of a user. That is, the mobile communication system provides an always-on service that allows a mobile terminal and a network to continuously maintain a Packet Data Protocol (PDP) connection to enable the network to transmit data to the mobile terminal, and provides a service that allows a network to notify the existence of download data to a mobile terminal in order to enable the mobile terminal to download the data without a request by a user by performing a data connection with the network. Examples of the service include a Microsoft e-mail service and an automatic multimedia message search service.

In order to provide the above services in a conventional mobile communication system, a mobile terminal synchronizes or downloads data by establishing a data connection through a PDP context signaling process with an access network when receiving a data download request or a data synchronization request from a server of the network. Herein, the data connection between the mobile terminal and the network may be maintained for a predetermined time without being released immediately after completion of the data download or synchronization by the mobile terminal. The reason for this is that the data connection release is controlled by the network, because the data connection is established not by the request of the mobile terminal but by the network. Specifically, if the access network of the mobile terminal is a Wideband Code Division Multiple Access (WCDMA) network, the mobile terminal maintains the corresponding channel for a long time if the network does not release the data connection or the PDP connection even after completion of the data download or synchronization by the mobile terminal.

The above-described situation is normal. However, if the mobile terminal frequently synchronizes or downloads a small amount of data (e.g., an update of state information of a called terminal or an update of header information indicating the reception of e-mails or messages), it increases power consumption, thus shortening the battery life.

### SUMMARY OF THE INVENTION

An aspect of the present invention is to address at least the above-mentioned problems and/or disadvantages and to provide at least the advantages below. Accordingly, an aspect of the present invention is to provide a method and apparatus for downloading data in a mobile communication system.

Another aspect of the present invention is to provide a method and apparatus of a mobile terminal for determining a network according to the amount of download data in a mobile communication system.

Another aspect of the present invention is to provide a method and apparatus of a server for notifying a mobile terminal, when there is data to be downloaded to the mobile terminal in a mobile communication system, the amount of the download data.

Another aspect of the present invention is to provide a method and apparatus of a mobile terminal for performing, when there is a small amount of data to download in a mobile communication system, a data connection by using a 2^{nd} Generation (2G) network system.

According to an aspect of the present invention, a method of a mobile terminal for downloading data in a mobile communication system is provided. The method includes receiving a transmit (TX) data existence indication message from a server, determining an access network according to an amount of TX data included in the received TX data existence indication message, performing a data connection through the access network, and receiving the data from the server.

According to another aspect of the present invention, a method of a server for downloading data in a mobile communication system is provided. The method includes measuring an amount of data to be transmitted to a mobile terminal, transmitting a transmit (TX) data existence indication message including information about the measured data amount to the mobile terminal, and transmitting the data to the mobile terminal.

According to another aspect of the present invention, an apparatus of a mobile terminal for downloading data in a mobile communication system is provided. The apparatus includes a communication module for receiving a transmit (TX) data existence indication message from a server, and a communication unit for determining an access network according to an amount of TX data included in the received TX data existence indication message and for controlling the communication unit to perform a data connection through the access network and to receive the data from the server.

According to another aspect of the present invention, an apparatus of a server for downloading data in a mobile communication system is provided. The apparatus includes a control unit for measuring an amount of data to be transmitted to a mobile terminal, and a communication module controlled by the control unit to transmit a transmit (TX) data existence indication message including information about the measured data amount to the mobile terminal and then to transmit the data to the mobile terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIGS. 1A and 1B are flow diagrams illustrating a data download process in a mobile communication system according to an exemplary embodiment of the present invention;

FIG. 2 is a block diagram illustrating a mobile terminal and a service server in a mobile communication system according to an exemplary embodiment of the present invention;

FIG. 3 is a flow diagram illustrating a data download process of a service server in a mobile communication system according to an exemplary embodiment of the present invention; and

FIG. 4 is a flow diagram illustrating a data download process of a mobile terminal in a mobile communication system according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a method and apparatus for a mobile terminal to determine a network according to an amount of download data in a mobile communication system and to download the data through the determined network. The exemplary embodiments of the present invention are similarly applicable to a case where a mobile terminal synchronizes or downloads data from a service server in a mobile communication system. For the sake of convenience, the following description is made of an exemplary case of downloading data. Also, the following description is made of an exemplary case where the mobile terminal supports Wideband Code Division Multiple Access (WCDMA) and General Packet Radio Service (GPRS), to which the present invention is not limited. Thus, it should be clearly understood that the exemplary embodiments of the present invention are also applicable to a case where the mobile terminal supports any other system.

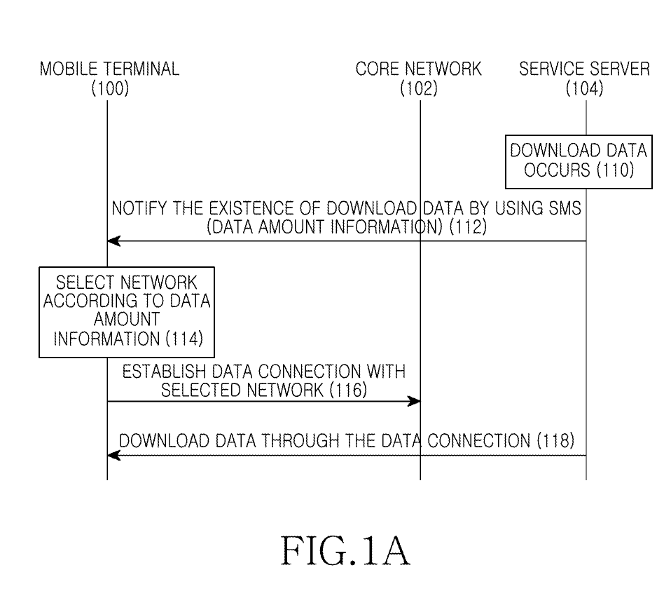

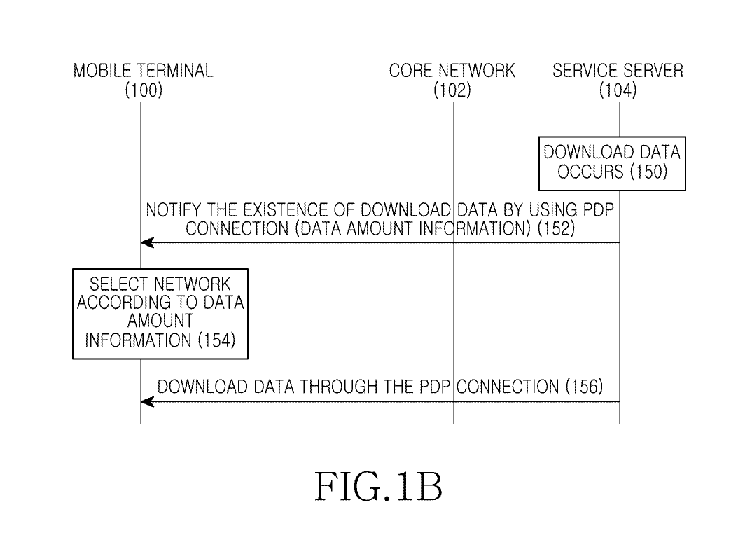

FIGS. 1A and 1B are flow diagrams illustrating a data download process in a mobile communication system according to an exemplary embodiment of the present invention. FIG. 1A illustrates a case where a Packet Data Protocol (PDP) connection is not performed between a mobile terminal and a network. FIG. 1B illustrates the case where a PDP connection is always performed between a mobile terminal and a network.

Referring to FIG. 1A, download data for a mobile terminal 100 occurs in step 110. In step 112, a service server 104 uses a Short Message Service (SMS) to notify the existence of the download data to the mobile terminal 100. Herein, the service server 104 specifies the download data amount (or size) in the short message transmitted to the mobile terminal 100. Herein, the service server 104 may classify the download data amount in a step-by-step manner. For example, the download data amount may be classified as ‘huge’, ‘large’, ‘medium’, ‘small’, and ‘a few’ in a step-by-step manner, which may be modified according to service providers or designers. Herein, if the download data for the mobile terminal 100 is streaming data, the download data amount may be classified as ‘unspecified’.

The mobile terminal 100 receives the short message indicating the existence of the download data from the service server 104 to detect the existence of the download data. In step 114, the mobile terminal 100 detects the amount of the download data from the received short message and selects a network according to the detected download data amount. For example, if the download data amount is smaller than a predetermined threshold value (or level), the mobile terminal 100 selects the GPRS network for the data download, regardless of the current access network. If the download data amount is greater than or equal to the predetermined threshold value (or level), the mobile terminal 100 selects the current access network. Herein, the reason for selecting the GPRS network if the download data amount is smaller than the predetermined threshold value (or level) is that the case of downloading a small amount of data through the GPRS network consumes less power than the case of downloading a small amount of data through the WCDMA network.

In step 116, the mobile terminal 100 accesses the selected network through a core network 102 to establish a data connection. In step 118, the mobile terminal 100 downloads data through the data connection. Thereafter, the mobile terminal 100 releases the data connection upon completion of the data download. Herein, the data connection is released at different points according to whether the network is WCDMA or GPRS. In general, if the network for the data connection is the WCDMA network, because the data connection is released by a network controller or by a timer, the data connection may be maintained for a predetermined time even after the completion of the data download. On the other hand, if the network for the data connection is the GPRS network, because a separate dedicated channel is not established, the data connection is released immediately after completion of the data download of the mobile terminal 100.

As described above, because the data connection release point depends on the selected network, the power consumption of the mobile terminal 100 depends on which network is used to download the data.

Table 1 illustrates the measured power consumption of a mobile terminal, depending on the selected network.

TABLE 1

| | Power | |
|---|---|---|
| | Consumption | Time |
| Unit | (mA) | (Hours) |
| WCDMA PS 384/64 kbps DL FTP | 253 | 3.2 |
| (Tx = +0 dBm) | | |
| GPRS 4 Rx/1 Tx, CS 2, DL FTP | 153 | 5.2 |
| (Tx = +13 dBm) | | |
| EDGE 4 Rx/1 Tx, MCS 5, DL FTP | 154 | 5.2 |
| (Tx = +13 dBm) | | |

Referring to Table 1, it may be seen that the case of downloading data to the mobile terminal through the WCDMA network consumes more power than the case of downloading data to the mobile terminal through the Enhanced Data rates for GSM Evolution (EDGE) network or the GPRS network that is a 2^{nd} Generation (2G) network. In the case of the WCDMA network, even when the mobile terminal completes the data download, if the network controller does not release a channel, the mobile terminal must continue to monitor the channel, thus consuming much power. On the other hand, in the case of the GPRS network, because a separate dedicated channel is not established for the data connection, no power is consumed after completion of the data download. Thus, in order to reduce the power consumption, exemplary embodiments of the present invention use the GPRS network to download when the amount of data is small.

Referring to FIG. 1B, download data for a mobile terminal 100 occurs in step 150. In step 152, a service server 104 notifies the existence of the download data to the mobile terminal 100. Herein, because the mobile terminal 100 already has a PDP connection with a network, the service server 104 may transmit a download data existence indication message to the mobile terminal through the PDP connection. Herein, the service server 104 specifies the download data amount (or size) in the download data existence indication message transmitted to the mobile terminal 100.

The mobile terminal 100 receives the download data existence indication message from the service server 104 to detect the existence of the download data. In step 154, the mobile terminal 100 detects the amount of the download data from the download data existence indication message and selects a network according to the download data amount. For example, if the download data amount is smaller than a predetermined threshold value (or level), the mobile terminal 100 selects the GPRS network. If the download data amount is greater than or equal to the predetermined threshold value (or level), the mobile terminal 100 selects the current access network. Herein, the reason for selecting the GPRS network if the download data amount is smaller than the predetermined threshold value (or level) is that the case of downloading a small amount of data through the GPRS network consumes less power than the case of downloading a small amount of data through the WCDMA network.

If the network selected according to the download data amount is identical to the current access network, the mobile terminal 100 establishes a data connection through the PDP connection to download the data through a dedicated channel at step 156. Thereafter, the mobile terminal 100 releases the data connection upon completion of the data download. At this point, because the PDP is always connected, the PDP connection is not released. Herein, the data connection is released at different points according to whether the network is a WCDMA network or a GPRS network. If the network selected according to the download data amount is different from the current access network, the mobile terminal 100 performs a data connection process with the selected network to download the data from the service server 104.

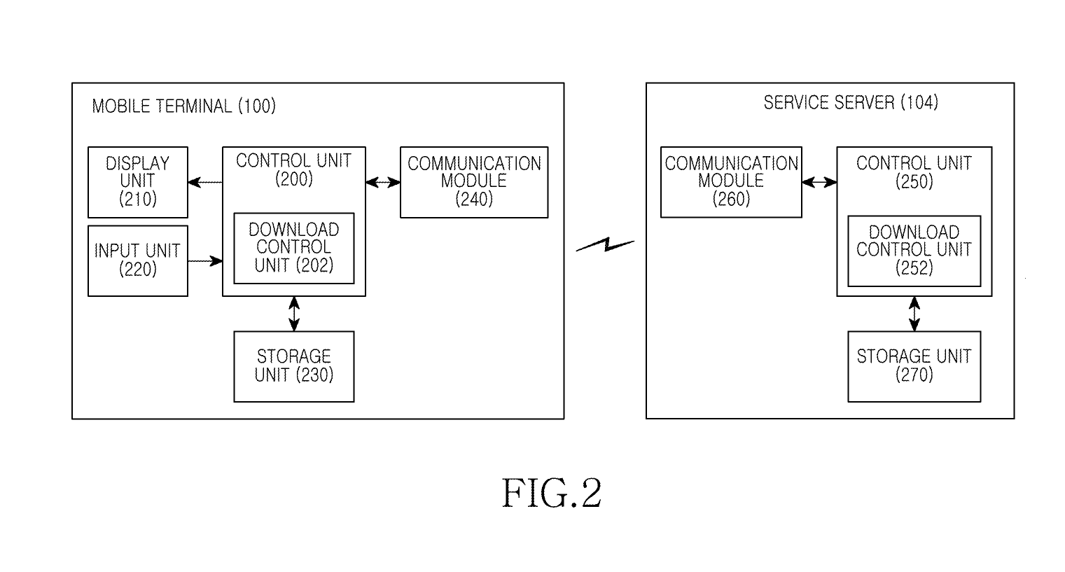

FIG. 2 is a block diagram illustrating a mobile terminal and a service server in a mobile communication system according to an exemplary embodiment of the present invention.

Referring to FIG. 2, the mobile terminal 100 of the mobile communication system includes a control unit 200, a display unit 210, an input unit 220, a storage unit 230, and a communication module 240. The service server 104 includes a control unit 250, a communication module 260, and a storage unit 270.

Regarding the mobile terminal 100, the control unit 200 controls an overall operation of the mobile terminal 100. According to exemplary embodiments of the present invention, the control unit 200 includes a download control unit 202 to determine the amount of download data from a message received from the service server 104, to determine a network according to the download data amount, and to download the data through the determined network.

That is, the download control unit 202 detects the amount of download data from a message received from the service server 104 and compares the download data amount with a predetermined threshold value (or level). If the download data amount is smaller than the predetermined threshold value (or level), the download control unit 202 selects the GPRS network regardless of the current access network and controls the communication module 240 to download the data through the GPRS network. On the other hand, if the download data amount is greater than or equal to the predetermined threshold value (or level), the download control unit 202 selects the current access network and controls the communication module 240 to download the data through the current access network.

The display unit 210 displays numerals and characters, moving pictures, still pictures, and status information generated during operation of the mobile terminal 100. The input unit 220 includes a keypad including at least one function key or a touch sensor for sensing the touch of a user. The input unit 220 provides the control unit 200 with data corresponding to a key selected by the user or coordinates corresponding to a point on the touch sensor touched by the user.

The storage unit 230 stores various data and programs necessary for operation of the mobile terminal 100, and temporarily stores various data generated during the operation of the mobile terminal 100. In particular, the storage unit 230 stores information of a threshold value (or level) that is used to determine a network for downloading data from the service server 104.

The communication module 240 transmits/receives (TX/RX) Radio Frequency (RF) signals inputted/outputted through an antenna. According to exemplary embodiments of the present invention, under the control of the control unit 200, the communication module 240 changes a frequency channel for processing a TX/RX signal, and operates in a GPRS or WCDMA mode to communicate signals with a GPRS or WCDMA cell.

Regarding the service server 104, the control unit 250 controls an overall operation of the service server 104. According to exemplary embodiments of the present invention, the control unit 250 includes a download control unit 252 to notify, when there is data to be downloaded to the mobile terminal 100, the existence of the download data to the mobile terminal 100. More particularly, the download control unit 252 detects an amount of the download data and transmits the detected download data amount to the mobile terminal 100. Herein, the service server 104 may classify the download data amount in a step-by-step manner. For example, the download data amount may be classified as ‘huge’, ‘large’, ‘medium’, ‘small’, and ‘a few’ in a step-by-step manner, which may be modified according to service providers or designers. Herein, if the download data for the mobile terminal 100 is streaming data, the service server 104 may classify the download data amount as ‘unspecified’.

The communication module 260 transmits signals to the mobile terminal 100, under the control of the control unit 250. The storage unit 270 stores various data and programs for operations of the service server 104, and stores data to be downloaded to each mobile terminal.

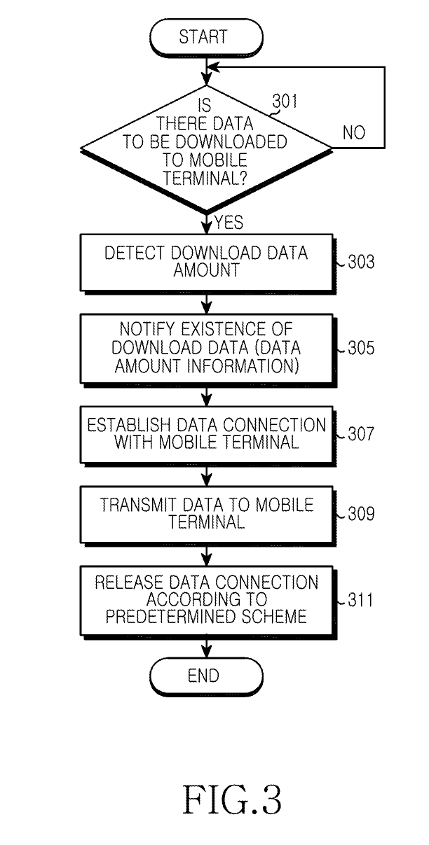

FIG. 3 is a flow diagram illustrating a data download process of a service server in a mobile communication system according to an exemplary embodiment of the present invention.

Referring to FIG. 3, in step 301, the server determines whether there is data to be downloaded to the mobile terminal. If there is data to be downloaded to the mobile terminal, the server proceeds to step 303. In step 303, the server detects the amount of the download data. In step 305, the server notifies the existence of the download data to the mobile terminal and transmits information about the download data amount to the mobile terminal. Herein, the server may classify the download data amount in a step-by-step manner. For example, the download data amount may be classified as ‘huge’, ‘large’, ‘medium’, ‘small’, and ‘a few’ in a step-by-step manner, which may be modified according to service providers or designers. Herein, if the download data for the mobile terminal is streaming data, the server may classify the download data amount as ‘unspecified’.

In step 307, the server establishes a data connection with the mobile terminal through a network. In step 309, the server transmits the download data to the mobile terminal.

In step 311, the server releases the data connection with the mobile terminal according to a predetermined scheme of the network. Thereafter, the server ends the algorithm according to an exemplary embodiment of the present invention.

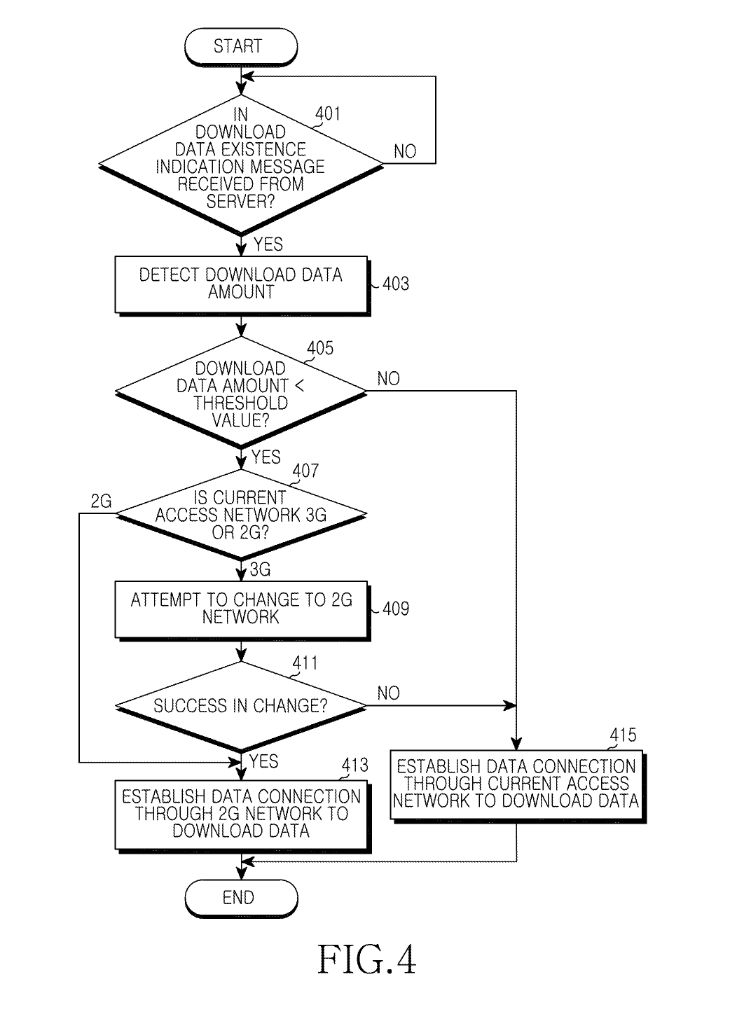

FIG. 4 is a flow diagram illustrating a data download process of a mobile terminal in a mobile communication system according to an exemplary embodiment of the present invention.

Referring to FIG. 4, in step 401, the mobile terminal determines whether a download data existence indication message is received from the server. Herein, the download data existence indication message may be received, for example, through a Short Message Service (SMS) or through a predetermined PDP connection for an always-on service.

If the download data existence indication message is received from the server in step 401, the mobile terminal proceeds to step 403. In step 403, the mobile terminal analyzes the download data existence indication message to detect the amount of the download data. In step 405, the mobile terminal compares the detected download data amount with a predetermined threshold value.

If the detected download data amount is greater than or equal to the predetermined threshold value, the mobile terminal determines to download the data through the current access network and proceeds to step 415. In step 415, the mobile terminal establishes a data connection through the current access network to download the data from the server. Thereafter, the mobile terminal ends the algorithm according to an exemplary embodiment of the present invention.

On the other hand, if the detected download data amount is smaller than the predetermined threshold value, the mobile terminal determines to download the data through a 2G system (e.g., GPRS) and proceeds to step 407. In step 407, the mobile terminal determines whether the current access network is a 3^{rd} Generation (3G) system or a 2G system. If the current access network is a 2G system, the mobile terminal proceeds directly to step 413. If the current access network is a 3G system, the mobile terminal proceeds to step 409. In step 409, the mobile terminal attempts to change to a 2G network. That is, the mobile terminal searches and accesses a base station of the 2G network belonging to the same core network.

In step 411, the mobile terminal determines whether it succeeds in changing to the 2G network, i.e., whether it succeeds in accessing the base station of the 2G network. If it does not succeed in changing to the 2G network, the mobile terminal proceeds to step 415. If it succeeds in changing to the 2G network, the mobile terminal proceeds to step 413. In step 413, the mobile terminal establishes a data connection through the 2G network to download the data from the server. Thereafter, the mobile terminal ends the algorithm according to this exemplary embodiment of the present invention.

Herein, when the mobile terminal completes the data download from the server, the data connection between the mobile terminal and the network may be released at different points according to the type of the access network. In general, if the network for the data connection is the WCDMA network, because the data connection is released by a network controller or by a timer, the data connection may be maintained for a predetermined time even after completion of the data download. On the other hand, if the network for the data connection is the GPRS network, because a separate dedicated channel is not established, the data connection is released immediately after completion of the data download of the mobile terminal. Thus, as described above, exemplary embodiments of the present invention use the GPRS network to download a small amount of data, thereby reducing the power consumption of the mobile terminal.

As described above, according to exemplary embodiments of the present invention, the server of the mobile communication system notifies the amount of download data or synchronization data to the mobile terminal. The mobile terminal selects a network according to the data amount and downloads the data through the selected network. Accordingly, in exemplary embodiments of the present invention, a small amount of data is downloaded through the 2G network and the data connection is released immediately after completion of the data download of the mobile terminal, thus making it possible to reduce the power consumption.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of a mobile terminal for downloading data in a mobile communication system, the method comprising:
receiving a transmit (TX) data existence indication message from a server;
determining an access network according to an amount of TX data included in the received TX data existence indication message;
performing a data connection through the access network; and
receiving the data through the access network from the server.

2. The method of claim 1, wherein the determining of the access network comprises:
comparing the TX data amount with a predetermined threshold value;
determining a 2^{nd} Generation (2G) network as the access network if the TX data amount is smaller than the predetermined threshold value; and
determining a current access network as the access network if the TX data amount is greater than or equal to the predetermined threshold value.

3. The method of claim 2, further comprising:
attempting to access the 2G network if determining the 2G network as the access network; and
performing a data connection through the current access network if fail to access the 2G network.

4. The method of claim 2, further comprising:
if the 2G network is determined as the access network, at the server, releasing the data connection immediately after the data is downloaded.

5. The method of claim 1, wherein the TX data existence indication message is received through a Short Message Service (SMS) or through a predetermined Packet Data Protocol (PDP) connection.

6. A method of a server for downloading data in a mobile communication system, the method comprising:
measuring an amount of data to be transmitted to a mobile terminal;
transmitting a transmit (TX) data existence indication message including information about the measured data amount to the mobile terminal; and
transmitting the data to the mobile terminal.

7. The method of claim 6, wherein the transmitting of the data further comprises establishing a data connection with the mobile terminal through a network determined by the mobile terminal and transmitting the data through the data connection.

8. The method of claim 7, further comprising:
if the network determined by the mobile terminal is a 2^{nd} Generation (2G) network, releasing the data connection immediately after transmitting the data.

9. The method of claim 6, wherein the TX data existence indication message is transmitted through a Short Message Service (SMS) or through a predetermined Packet Data Protocol (PDP) connection.

10. An apparatus of a mobile terminal for downloading data in a mobile communication system, the apparatus comprising:
a communication module for receiving a transmit (TX) data existence indication message from a server; and
a control unit for determining an access network according to an amount of TX data included in the received TX data existence indication message, and for controlling the communication unit to perform a data connection through the access network and to receive the data from the server.

11. The apparatus of claim 10, wherein the control unit compares the TX data amount with a predetermined threshold value, determines a 2^{nd} Generation (2G) network as the access network if the TX data amount is smaller than the predetermined threshold value, and determines a current access network as the access network if the TX data amount is greater than or equal to the predetermined threshold value.

12. The apparatus of claim 11, wherein if determining the 2G network as the access network, the control unit attempts to access the 2G network, and performs a data connection through the current access network if fail to access the 2G network.

13. The apparatus of claim 10, wherein the TX data existence indication message is received through a Short Message Service (SMS) or through a predetermined Packet Data Protocol (PDP) connection.

14. An apparatus of a server for downloading data in a mobile communication system, the apparatus comprising:
a control unit for measuring an amount of data to be transmitted to a mobile terminal; and
a communication module controlled by the control unit to transmit a transmit (TX) data existence indication message including information about the measured data amount to the mobile terminal and then to transmit the data to the mobile terminal.

15. The apparatus of claim 14, wherein the data is transmitted to the mobile terminal through a data connection established with the mobile terminal through a network determined by the mobile terminal.

16. The apparatus of claim 15, wherein if the network is determined to be a 2^{nd} Generation (2G) network, the controller controls to release the data connection immediately after the data is transmitted.

17. The apparatus of claim 14, wherein the TX data existence indication message is transmitted through a Short Message Service (SMS) or through a predetermined Packet Data Protocol (PDP) connection.
